(19) United States
(12) Patent Application Publication
(10) Pub. No.: US 2022/0383412 A1
(43) Pub. Date: Dec. 1, 2022

(54) METHODS, APPARATUSES AND SYSTEMS FOR FIRST LOOK MATCHING OF ORDERS

(71) Applicant: CFPH, LLC, New York, NY (US)

(72) Inventor: Jacob Loveless, New York, NY (US)

(21) Appl. No.: 17/883,788

(22) Filed: Aug. 9, 2022

Related U.S. Application Data
(63) Continuation of application No. 14/074,126, filed on Nov. 7, 2013.

(51) Int. Cl. G06Q 40/04

(52) U.S. Cl. CPC G06Q 40/04

(57) ABSTRACT

Various embodiments are directed to a trading system and method for matching orders between liquidity takers and liquidity providers. A memory stores instructions which, when executed, direct the processor to perform various actions, such as the following. The processor may receive from a liquidity taker, an order to trade on an exchange. The order is routed to at least one liquidity provider with a target fill rate above a specific percentage. A response is received from the at least one liquidity provider. Based on the received response, the processor may update an actual fill rate of the at least one liquidity provider. The processor may determine, based on comparing the liquidity provider's actual fill rate with the target fill rate, a level of performance for the at least one liquidity provider. The processor may transmit a report about the at least one liquidity provider's level of performance.

### CROSS-REFERENCE TO RELATED APPLICATIONS

This application is a continuation of U.S. patent application Ser. No. 14/074,126 filed Nov. 7, 2013, the disclosure of which is incorporated by reference herein in its entirety.

### BACKGROUND

Trading parties typically submit trading orders for security prices and quantities they are willing to trade. The parties submitting orders are generally referred to as “liquidity takers”, and the parties that are able to execute the order are generally referred to as “liquidity providers.” In certain markets, such as foreign exchange, trades are traditionally executed by “second look.” Under second look, a liquidity taker submits an order that is routed to a liquidity provider. The liquidity provider has a period of time to decide whether to accept the order (e.g., respond with “done”) or deny the order (e.g. respond with “no or fail to respond). This period of time to decide often leads to uncertainty for the liquidity taker, especially where a large quantity of money is tied to the submitted order.

### BRIEF SUMMARY

Various embodiments are directed to matching orders between liquidity takers and liquidity providers based on a “first look” process. In some embodiments, orders from liquidity takers are immediately matched with liquidity providers having a target fill rate above a certain percentage.

### BRIEF DESCRIPTION OF THE DRAWINGS

FIG. 1 depicts a system according to at least one embodiments of the methods disclosed herein.

FIG. 2 depicts a flow diagram according to ate least one embodiment of the methods disclosed herein.

FIG. 3 depicts a flow diagram according to ate least one embodiment of the methods disclosed herein.

FIG. 4 depicts a flow diagram according to ate least one embodiment of the methods disclosed herein.

### DETAILED DESCRIPTION

The following sections I-X provide a guide to interpreting the present application.

### I. Terms

The term “product” means a machine, manufacture and/or composition of matter, unless expressly specified otherwise.

The term “process” means a process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere description of a process, or in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the invention”, unless expressly specified otherwise.

The term “variation” of an invention means an embodiment of the invention, unless expressly specified otherwise.

The term “indication” is used in an extremely broad sense. An “indication” of a thing should be understood to include anything that may be used to determine the thing.

An indication of a thing may include an electronic message that identifies the thing (e.g., an identification of a widget by a serial number affixed to the widget, an identification of a widget by one or more characteristics of the widget). An indication of a thing may include information that may be used to compute and/or look-up a thing (e.g., information identifying a machine of which a widget is a part that may be used to determine the widget). An indication of a thing may specify things that are related to the thing (e.g., characteristics of the thing, a name of the thing, a name of a thing related to the thing). An indication of a thing may not specify things that are related to the thing (e.g., a letter “a” may be an indication of a widget of a computer system that is configured to interpret the letter “a” to identify the widget). An indication of a thing may include a sign, a symptom, and/or a token of the thing. An indication, for example, may include a code, a reference, an example, a link, a signal, and/or an identifier. An indication of a thing may include information that represents, describes, and/or otherwise is associated with the thing.

A transformation of an indication of a thing may be an indication of the thing (e.g., an encrypted indication of a thing may be an indication of the thing). An indication of a thing may include the thing itself, a copy of the thing, and/or a portion of the thing. An indication of a thing may be meaningless to a thing that is not configured to understand the indication (e.g., a person may not understand that a letter “a” indicates a widget, but it may nonetheless be an indication of the widget because the computer system may determine the widget from the letter “a”). It should be understood that the fact that an indication of a thing may be used to determine the thing does not mean that the thing or anything else is determined. An indication of a thing may include an indication of any number of the thing unless specified otherwise. An indication of a thing may include an indication of other things (e.g., an electronic message that indicates may things). (Indication can be used as a very broad term in claim language. For example: receiving an indication of a financial instrument.)

The term “represent” means (1) to serve to express, designate, stand for, or denote, as a word, symbol, or the like does; (2) to express or designate by some term, character, symbol, or the like; (3) to portray or depict or present the likeness of, as a picture does; or (4) to serve as a sign or symbol of.

A reference to “another embodiment” in describing an embodiment does not imply that the referenced embodiment is mutually exclusive with another embodiment (e.g., an embodiment described before the referenced embodiment), unless expressly specified otherwise. Similarly, the mere fact that two (or more) embodiments are referenced does not imply that those embodiments are mutually exclusive.

One embodiment of the invention may include or cover or embrace more than one other embodiment of the invention. For example, a first embodiment comprising elements a, b, and c may cover a second embodiment that comprises elements a, b, c, and d as well as a third embodiment covering elements a, b, c, and e. Similarly, each of the first, second, and third embodiments may cover a fourth embodiment comprising elements a, b, c, d, and e.

The terms “including”, “comprising” and variations thereof mean “including but not necessarily limited to”, unless expressly specified otherwise. Thus, for example, the sentence “the machine includes a red widget and a blue widget” means the machine includes the red widget and the blue widget but may possibly include one or more other items as well.

The term “consisting of” and variations thereof mean “including and also limited to”, unless expressly specified otherwise. Thus, for example, the sentence “the machine consists of a red widget and a blue widget” means the machine includes the red widget and the blue widget but does not include anything else.

The term “compose” and variations thereof mean “to make up the constituent parts of, component of, or member of”, unless expressly specified otherwise. Thus, for example, the sentence “the red widget and the blue widget compose a machine” means the machine includes the red widget and the blue widget.

The term “exclusively compose” and variations thereof mean “to make up exclusively the constituent parts of, to be the only components of, or to be the only members of”, unless expressly specified otherwise. Thus, for example, the sentence “the red widget and the blue widget exclusively compose a machine” means the machine consists of the red widget and the blue widget (i.e. and nothing else).

The terms “a”, “an” and “the” refer to “one or more”, unless expressly specified otherwise. Thus, for example, the phrase “a widget” means one or more widgets, unless expressly specified otherwise. Similarly, after reciting the phrase “a widget”, a subsequent recitation of the phrase “the widget” means “the one or more widgets”. Accordingly, it should be understood that the word “the” may also refer to a specific term having antecedent basis. For example, if a paragraph mentions “a specific single feature” and then refers to “the feature,” then the phrase “the feature” should be understood to refer to the previously mentioned “a specific single feature.” (It should be understood that the term “a” in “a specific single feature” refers to “one” specific single feature and not “one or more” specific single features.)

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things. For example, the phrase “at least one of a widget, a car and a wheel” does not mean “one widget, one car and one wheel”.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” covers both “based only on” and “based at least on”. The phrase “based at least on” is equivalent to the phrase “based at least in part on”. For example, the phrase “element A is calculated based on element B and element C” covers embodiments where element A is calculated as the product of B times C (in other words, A=B×C), embodiments where A is calculated as the sum of B plus C (in other words, A=B+C), embodiments where A is calculated as a product of B times C times D, embodiments where A is calculated as a sum of the square root of B plus C plus D times E, and so on.

The terms “represent” and like terms are not exclusive, unless expressly specified otherwise. For example, the term “represents” does not mean “represents only”, unless expressly specified otherwise. For example, the phrase “the data represents a credit card number” covers both “the data represents only a credit card number” and “the data represents a credit card number, and the data also represents something else”.

The term “whereby” is used herein only to precede a clause or other set of words that express only the intended result, objective or consequence of something that is explicitly recited before the term “whereby”. Thus, when the term “whereby” is used in a claim, the clause or other words that the term “whereby” modifies do not establish specific further limitations of the claim or otherwise restrict the meaning or scope of the claim.

The terms “e.g.”, “such as” and like terms mean “for example”, and thus do not limit the term or phrase they explain. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first of the two machines has a function and the second of the two machines has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

A numerical range includes integers and non-integers in the range, unless expressly specified otherwise. For example, the range “1 to 10” includes the integers from 1 to 10 (e.g., 1, 2, 3, 4, . . . 9, 10) and non-integers (e.g., 1.0031415926, 1.1, 1.2, . . . 1.9).

Where two or more terms or phrases are synonymous (e.g., because of an explicit statement that the terms or phrases are synonymous), instances of one such term or phrase does not mean instances of another such term or phrase must have a different meaning. For example, where a statement renders the meaning of “including” to be synonymous with “including but not limited to”, the mere usage of the phrase “including but not limited to” does not mean that the term “including” means something other than “including but not limited to”.

### II. Determining

The term “determining” and grammatical variants thereof (e.g., to determine a price, determining a value, the determination of an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), rendering into electronic format or digital representation, ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing, averaging and the like.

The term “determining” does not imply that mathematical processing must be performed and does not imply that numerical methods must be used and does not imply that an algorithm is used.

The term “determining” does not imply that any particular device must be used. For example, a computer need not necessarily perform the determining.

The term “determining” may include “calculating”. The term “calculating” should be understood to include performing one or more calculations. Calculating may include computing, processing, and/or deriving. Calculating may be performed by a computing device. For example, calculating a thing may include applying an algorithm to data by a computer processor and generating the thing as an output of the processor.

The term “determining” may include “referencing”. The term “referencing” should be understood to include making one or more reference, e.g., to a thing. Referencing may include querying, accessing, selecting, choosing, reading, and/or looking-up. The act of referencing may be performed by a computing device. For example, referencing a thing may include reading a memory location in which the thing is stored by a processor.

The term “determining” may include “receiving”. For example, receiving a thing may include taking in the thing. In some embodiments, receiving may include acts performed to take in a thing, such as operating a network interface through which the thing is taken in. In some embodiments, receiving may be performed without acts performed to take in the thing, such as in a direct memory write or a hard wired circuit. Receiving a thing may include receiving a thing from a remote source that may have calculated the thing.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to that limitation (e.g., “the widget”), this mere usage does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term, but that ordinal number does not have any other meaning or limiting effect — it is merely a convenient name. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. The mere usage of ordinal numbers does not define a numerical limit to the features identified with the ordinal numbers. For example, the mere usage of the ordinal numbers “first” and “second” before the term “widget” does not indicate that there are exactly two widgets.

When a single device, article or other product is described herein, in another embodiment more than one device or article (whether or not they cooperate) may alternatively be used in place of the single device or article that is described. Accordingly, the functionality that is described as being possessed by a device may alternatively be possessed by more than one device or article (whether or not they cooperate) in another embodiment.

Similarly, where more than one device, article or other product is described herein (whether or not they cooperate), in another embodiment a single device or article may alternatively be used in place of the more than one device or article that is described. For example, a plurality of computer-based devices may be substituted with a single computer-based device. In some embodiments, such a plurality of computer-based devices may operate together to perform one step of a process such as is common in grid computing systems. In some embodiments, such a plurality of computer-based devices may operate provide added functionality to one another so that the plurality may operate to perform one step of a process such as is common in cloud computing systems. (Conversely, a single computer-based device may be substituted with multiple computer-based devices operating in cooperation with one another. For example, a single computing device may be substituted with a server and a workstation in communication with one another over the internet). Accordingly, the various functionality that is described as being possessed by more than one device or article may alternatively be possessed by a single device or article.

The functionality and/or the features of a single device that is described may, in another embodiment, be alternatively embodied by one or more other devices which are described but are not explicitly described as having such functionality or features. Thus, other embodiments need not include the described device itself, but rather can include the one or more other devices which would, in those other embodiments, have such functionality or features.

### IV. Disclosed Examples and Terminology Are Not Limiting

Neither the Title (set forth at the beginning of the first page of the present application) nor the Abstract (set forth at the end of the present application) is to be taken as limiting in any way the scope of the disclosed invention, is to be used in interpreting the meaning of any claim or is to be used in limiting the scope of any claim. An Abstract has been included in this application merely because an Abstract is required under 37 C.F.R. § 1.72(b).

The headings of sections provided in the present application are for convenience only and are not to be taken as limiting the disclosure in any way.

Numerous embodiments are described in the present application and are presented for illustrative purposes only. The described embodiments are not, and are not intended to be, limiting in any sense. The disclosed invention is widely applicable to numerous embodiments, as is readily apparent from the disclosure. One of ordinary skill in the art will recognize that the disclosed invention may be practiced with various modifications and alterations, such as structural, logical, software, and electrical modifications. Although particular features of the disclosed invention may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not be interpreted as requiring features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or (with respect to a claim and the invention defined by that claim) expressly recited in that claim.

Any preambles of the claims that recite anything other than a statutory class shall be interpreted to recite purposes, benefits and possible uses of the claimed invention, and such preambles shall not be construed to limit the claimed invention.

The present disclosure is not a literal description of all embodiments of the invention. Also, the present disclosure is not a listing of features of the invention which must be present in all embodiments.

All disclosed embodiments are not necessarily covered by the claims (even including all pending, amended, issued and canceled claims). In addition, a disclosed embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries. Devices are in communication with one another if they are capable of at least one-way communication with one another. For example, a first device is in communication with a second device if the first device is capable of transmitting information to the second device. Similarly, the second device is in communication with the first device if the second device is capable of receiving information from the first device.

A description of an embodiment with several components or features does not imply that all or even any of such components or features are required. On the contrary, a variety of optional components are described to illustrate the wide variety of possible embodiments of the present invention. Unless otherwise specified explicitly, no component or feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are preferred, essential or required. Various other embodiments within the scope of the described invention include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, and a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

The term “compute” shall mean to determine using a processor in accordance with a software algorithm.

A “processor” means one or more microprocessors, central processing units (CPUs), computing devices, microcontrollers, digital signal processors, graphics processing units (GPUs) or like devices or any combination thereof, regardless of the architecture (e.g., chip-level multiprocessing or multi-core, RISC, CISC, Microprocessor without Interlocked Pipeline Stages, pipelining configuration, simultaneous multithreading, microprocessor with integrated graphics processing unit, GPGPU).

A “computing device” means one or more microprocessors, central processing units (CPUs), computing devices, microcontrollers, digital signal processors, graphics card, mobile gaming device, or like devices or any combination thereof, regardless of the architecture (e.g., chip-level multiprocessing or multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process. For example, a description of a process is a description of an apparatus comprising a processor and memory that stores a program comprising instructions that, when executed by the processor, direct the processor to perform the method.

The apparatus that performs the process can include a plurality of computing devices that work together to perform the process. Some of the computing devices may work together to perform each step of a process, may work on separate steps of a process, may provide underlying services that other computing devices that may facilitate the performance of the process. Such computing devices may act under instruction of a centralized authority. In another embodiment, such computing devices may act without instruction of a centralized authority. Some examples of apparatus that may operate in some or all of these ways may include grid computer systems, cloud computer systems, peer-to-peer computer systems, computer systems configured to provide software as a service, and so on. For example, the apparatus may comprise a computer system that executes the bulk of its processing load on a remote server, but outputs display information to and receives user input information from a local user computer, such as a computer system that executes VMware software.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any non-transitory medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

The term “tangible computer-readable medium” refers to a “computer-readable medium” that comprises a hardware component, such as optical or magnetic disks.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), wireless local area network communication defined by the IEEE 802.11 specifications whether or not they are approved by the Wi-Fi Alliance, SAP, ATP, Bluetooth™, and TCP/IP, TDMA, CDMA, and 3G; and/or (iv) encrypted to ensure privacy or prevent fraud in any of a variety of ways well known in the art.

The term “database” refers to any electronically-stored collection of data that is stored in a retrievable format.

The term “data structure” refers to a database in a hardware machine such as a computer.

The term “network” means a series of points or nodes interconnected by communication paths. For example, a network can include a plurality of computers or communication devices interconnected by one or more wired and/or wireless communication paths. Networks can interconnect with other networks and contain subnetworks.

The term “predetermined” means determined beforehand, e.g., before a present time or a present action. For example, the phrase “displaying a predetermined value” means displaying a value that was determined before the act of displaying.

The term “condition” means (1) a premise upon which the fulfillment of an agreement depends, or (2) something essential to the appearance or occurrence of something else.

The term “transaction” means (1) an exchange or transfer of goods, services, or funds, or (2) a communicative action or activity involving two parties or things that reciprocally affect or influence each other.

Thus a description of a process is likewise a description of a computer-readable medium storing a program for performing the process. The computer-readable medium can store (in any appropriate format) those program elements which are appropriate to perform the method. For example, a description of a process is a description of a computer-readable storage medium that stores a program comprising instructions that, when executed by a processor, direct the processor to perform the method.

Just as the description of various steps in a process does not indicate that all the described steps are required, embodiments of an apparatus include a computer or computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel®, Pentium®, or Centrino™, Atom™ or Core™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

As used herein, the term “encryption” refers to a process for obscuring or hiding information so that the information is not readily understandable without special knowledge. The process of encryption may transform raw information, called plaintext, into encrypted information. The encrypted information may be called ciphertext, and the algorithm for transforming the plaintext into ciphertext may be referred to as a cipher. A cipher may also be used for performing the reverse operation of converting the ciphertext back into plaintext. Examples of ciphers include substitution ciphers, transposition ciphers, and ciphers implemented using rotor machines.

In various encryption methods, ciphers may require a supplementary piece of information called a key. A key may consist, for example, of a string of bits. A key may be used in conjunction with a cipher to encrypt plaintext. A key may also be used in conjunction with a cipher to decrypt ciphertext. In a category of ciphers called symmetric key algorithms (e.g., private-key cryptography), the same key is used for both encryption and decryption. The sanctity of the encrypted information may thus depend on the key being kept secret. Examples of symmetric key algorithms are DES and AES. In a category of ciphers called asymmetric key algorithms (e.g., public-key cryptography), different keys are used for encryption and decryption. With an asymmetric key algorithm, any member of the public may use a first key (e.g., a public key) to encrypt plaintext into ciphertext. However, only the holder of a second key (e.g., the private key) will be able to decrypt the ciphertext back into plaintext. An example of an asymmetric key algorithm is the RSA algorithm.

### VI. Continuing Applications

The present disclosure provides, to one of ordinary skill in the art, an enabling description of several embodiments and/or inventions. Some of these embodiments and/or inventions may not be claimed in the present application but may nevertheless be claimed in one or more continuing applications that claim the benefit of priority of the present application.

Applicants intend to file additional applications to pursue patents for subject matter that has been disclosed and enabled but not claimed in the present application.

### VII. 35 U.S.C. § 112, Paragraph 6

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### VIII. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application will be prefaced by the phrase “does not include” or by the phrase “cannot perform”.

### IX. Incorporation By Reference

Any patent, patent application or other document referred to herein is incorporated by reference into this patent application as part of the present disclosure, but only for purposes of written description and enablement in accordance with 35 U.S.C. § 112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference. Conversely, the definitions provided in this application should not be used to limit, define, or otherwise construe any term of any document incorporated herein by reference. The definitions set forth explicitly in this application are controlling notwithstanding the description of particular embodiments that may be incompatible with the definition(s).

Any incorporation by reference does not, in and of itself, imply any endorsement of, ratification of, or acquiescence in any statements, opinions, arguments or characterizations contained in any incorporated patent, patent application or other document, unless explicitly specified otherwise in this patent application.

### X. Prosecution History

In interpreting the present application (which includes the claims), one of ordinary skill in the art refers to the prosecution history of the present application, but not to the prosecution history of any other patent or patent application, regardless of whether there are other patent applications that are considered related to the present application, and regardless of whether there are other patent applications that share a claim of priority with the present application.

### Detailed Description of Exemplary Embodiments

Various embodiments are directed to a method, apparatus and system for matching orders between liquidity takers and liquidity providers on a system. A memory stores instructions which, when executed, direct the at least one processor to perform various actions, such as the following. The processor may receive from a liquidity taker, an order to trade on an exchange. The order is routed to at least one liquidity provider with a target fill rate that is above a specific percentage. A response is received from the at least one liquidity provider. The response may indicate either an acceptance or a denial of the order. Based on the received response, the processor may update an actual fill rate of the at least one liquidity provider. The processor may determine, based on comparing the at least one liquidity provider's actual fill rate with the target fill rate, a level of performance for the at least one liquidity provider. The processor may transmit a report about the at least one liquidity provider's level of performance.

In some embodiments, the exchange comprises an electronic exchange system. The exchange also may comprise at least one of: a foreign exchange, an over-the-counter (OTC) market, an auction-based exchange, and a screen-based exchange. The at least one liquidity provider may agree to the target fill rate prior to trading on the exchange. The at least one liquidity provider may agree to the specific percentage of the target fill rate prior to trading on the exchange. In some embodiments, exchange is operable on a cloud computing system.

In some embodiments, the at least one liquidity provider responds with a denial of the order, in which the denial comprises an express rejection of the order. In other embodiments, the denial comprises the at least one liquidity provider providing no response within a period of time for responding.

In some embodiments, the processor may determine the level of performance for the at least one liquidity provider by comparing the actual fill rate with the target fill rate to determine a level of performance. The processor may determine that the actual fill rate fails to meet the target fill rate. The actual fill rate may have failed to meet the target fill rate for a period of time. An indication that the actual fill rate failed to meet the target fill rate may be transmitted to the at least one liquidity provider.

In some embodiments, in response to the actual fill rate, failing to meet the target fail rate, the processor may prevent any future orders from being routed to the at least one liquidity provider during a penalty period of time. The penalty period may be agreed upon prior to trading on the system.

In some embodiments, the processor provides the at least one liquidity provider with an opportunity to improve the actual fill rate. The opportunity to improve may be offered for a period of time. If at the end of the period of time to improve, the actual fill rate is still below the target fill rate, the at least one liquidity provider is preventing from receiving an orders for a penalty period of time.

In some embodiments, the processor may determine that the at least one liquidity provider triggers a threshold quantity of denials. An indication that the actual fill rate fails to meet the target fill rate may be transmitted to the liquidity provider. In response to the at least one liquidity provider triggering the threshold quality of denials, the processor may prevent any future orders from being routed to the liquidity provider during a penalty period of time. In some embodiments, the processor provides the at least one liquidity provider with an opportunity to improve the actual fill rate. The opportunity to improve may be offered for a period of time. If at the end of the period of time to improve, the actual fill rate is still below the target fill rate, the at least one liquidity provider is preventing from receiving an orders for a penalty period of time.

Various embodiments are directed to a method, apparatus and system for matching orders between liquidity takers and liquidity providers on an exchange. A memory stores instructions which, when executed, direct the at least one processor to perform various actions, such as the following. The processor may receive, based on a target fill rate being above a specific percentage, at least one order to be traded on an exchange. A response indicating either an acceptance or a denial of the received order may be transmitted. A report about a level of performance on the exchange is received. The level of performance is based on comparing the target fill rate with an actual fill rate.

In some embodiments, the actual fill rate is update after each response. The target fill rate may be determined prior to trading on the system.

In some embodiments, an indication that the actual fill rate fails to meet the target fill rate is received. In response to the actual fill rate failing to meet the target fail rate, the processor may receive an indication that any future orders will be prevented from being routed for a penalty period of time.

In some embodiments, an indication that a threshold quantity of denials has been triggered. In response to the threshold quality of denials being triggered, receiving an indication that any future orders will be prevented from being routed for a penalty period of time.

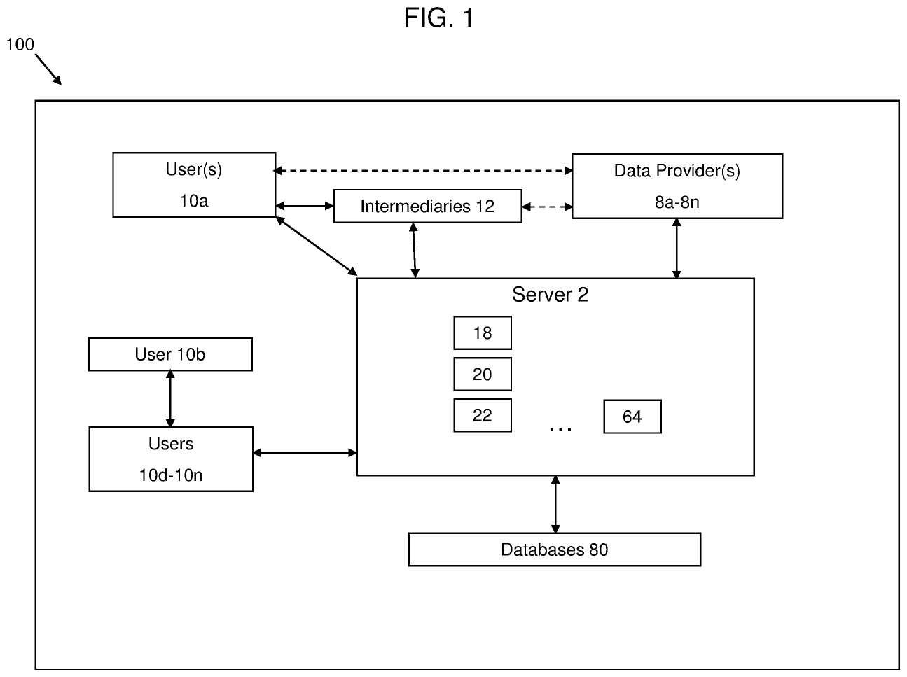

### FIG. 1. Exemplary System

Some embodiments of the present invention provide systems and methods for matching orders between liquidity takers and liquidity providers based on a “first look.” FIG. 1 depict a system according to at least one embodiment of the systems disclosed herein.

The system 100 may comprise one or more servers 2 coupled to one or more databases 80, one or more data providers 8a-8n, one or more end users 10a-10n, and one or more agents 12. The data providers 8a-8n, users 10a-n, agents 12, and server 2 may each communicate with each other. Users 10a-n may also communicate with other users 10a-n.

System 100 and server 2 may perform the functions described herein for a foreign exchange, an OTC market, an auction-based exchange, a screen-based exchanged, or any financial market.

Server 2 may comprise one or more processors, computers, computer systems, computer networks, and or computer databases. Server 2 may comprise modules 18-64. Server 2 also may comprise one or more databases, such as database 80. Server 2 may communicate with users 10a-n, data providers 8, and agents 12. For instance, server 2 may communicate with a user 10a-n computer, such as a browser of a user computer, e.g. over the Internet.

Database 80 may comprise one or more processors, computers, computer systems, computer networks, and/or computer databases configured to store information. Each of database 80 may communicate with server 2, e.g., via one or more modules of server 2. For instance, search module may search one or more financial databases (e.g., a database that stores orders or counter-party preference information), e.g. via the internet, to determine one or more securities or orders that satisfy one or more parameters, such as parameters based on preferences from a user.

Price module 18 may determine and associate one or more values or prices with one or more orders, securities, portfolios or other financial entities, e.g., as described herein. For instance, price module 18 may determine a price, e.g. for an order, or to be paid to or received by a user or server, e.g., for one or more securities. For instance, price module may determine a price or value (such as a net present value) that an entity such as a liquidity taker is willing to pay for or a liquidity provider is willing to sell a particular trading order (e.g., quantity of a security offers for purchase or sale). Prices may include a current price, a historical price (e.g., a price such as a market price at a prior time, such as a week earlier), and an estimated future price (e.g., based on changing price information, such as a recent increase or decrease in a price over a recent period of time).

### Databases

As shown in FIG. 1, a database 80 may be coupled to server 2. Database 80 may comprise a plurality of databases as described below. Databases 80 may store information about users, elements, and other information.

The modules may function separately or in various combinations. While the modules are shown within a single server, the modules also may operate among several servers. The modules may communicate with a plurality of databases, which also may function collectively or separately.

The modules of server 2 may store, access and otherwise interact with various sources of data, including external data, databases and other inputs.

### An Exemplary Method

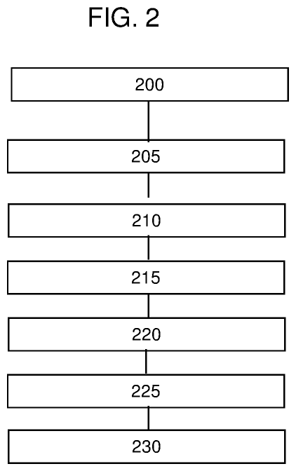

FIG. 2 depicts a flow diagram according to at least one embodiment of the methods disclosed herein.

It should be understood that each function(s) described for each block may be performed using a module capable of performing that function, e.g. according to methods described for each module above. It should also be appreciated that the acts described in these blocks may be performed in any order (including but not limited to the exemplary ordering shown on the diagram), and not all blocks need be performed.

In block 200, system 100 enters into agreements with liquidity providers. In some embodiments, these agreements state that a given liquidity provider will agree to fill a certain percentage of buy/sell orders that it receives. In some embodiments, the liquidity provider agrees to respond with an acceptance of an order (e.g., respond with a “done”) within a certain time frame. This time frame may be any increment of time. For example, the liquidity provider may agree to respond within 1 second or less. Every provider may have a different agreement with system 100.

In some embodiments, several liquidity providers may stream the same price. A liquidity taker may see the market and submit a buy/sell order at a certain price and size. In some embodiments, system 100 sends the order to all liquidity providers that are showing a market at the requested price. In other embodiments, the liquidity taker may indicate a desired to be matched only with a liquidity provider having a minimum target fill rate (e.g., above 85%). As such, system 100 may filter out the liquidity providers with target fill rates that falls below the requested target fill rate. In other embodiments, system 100 may automatically filter out liquidity providers with target fill rates that fall below a certain percentage, without any express request from the liquidity taker. For example, system 100 may determine that only liquidity providers with target fill rates above 85% are permitted to see all orders. System may have a tiered structure in which liquidity providers are divided into certain levels based on their target fill rates. The level that a liquidity provider is assigned determined the quantity and or quality of the orders that it see and receives. For example, system 100 may have a rule, in which all order are routed to liquidity providers with a target fill rate that is above 90%. Liquidity providers with more conservative target fill rates, such as 60%, may not receive all available orders. Thus, liquidity providers have an incentive to agree to a higher target fill rate. The target fill rate is designated by the liquidity provider prior to being allowed to trade on system 100. In some embodiments, all prospective liquidity providers on system 100 may be prompted to indicate a target fill rate before being allowed to trade on system 100.

In block 205, system 100 (e.g., one or more processors of server 2) may receive an order, e.g., as described herein. The order may be submitted by a liquidity taker. The order may be traded on an exchange. In some embodiments, the exchange may be the foreign exchange. In other embodiments, the exchange may be an Over-the-Counter market. In other embodiments, the exchange is an auction-based exchange, such as the New York Stock Exchange (NYSE). In another embodiment, the exchange is an electronic screen-based exchange, such as NASDAQ, where buyers and sellers are connected over a network. In some embodiments, the exchange is operable on a cloud computing system, which is detailed herein.

In block 210, a processor may route the order to at least one liquidity provider having a target fill rate above a specific percentage. In block 215, a processor may receive a response from a liquidity provider which indicates either an acceptance or denial of a routed order. In some embodiments, a denial is indicated by an express rejection from the liquidity provider. In other embodiments, a denial is indicated by a lack of response from the liquidity provider over a period of time. For example, if a liquidity provider does not respond to a route order within 1 minute, system 100 will interpret the lack of response as a “no.” In some embodiments, a liquidity provider may respond with “done” but the order may be matched with a different liquidity provider. For example, system 100 may match the order with the first liquidity provider that responds. In such instances, despite not being awarded the order, the liquidity provider's response of “done” still counts positively towards the actual fill rate.

In block 220, a processor may update the liquidity provider's actual fill rate based on the responses that the liquidity provider gives for routed orders. A denial from a liquidity provider counts negatively towards the provider's actual fill rate. Similarly, a response of “done”, or an acceptance of an order from the liquidity provider counts positively towards the providers' actual fill rate. For example, if a liquidity provider only accepts 3 out of 5 routed orders, then system calculates the liquidity provider as having an actual fill rate of 60%.

System 100 calculates a liquidity provider's actual fill rate over a pre-determined period of time. In some embodiments, system 100 calculate the actual fill rate over the course of a day. In other embodiments, system 100 may calculate the actual fill rate over a week, a month, or any increment of time. In some embodiments, the system100 dynamically updates the liquidity provider's actual fill rate with each response to a routed order.

In block 225, the processor may compare the liquidity provider's actual fill rate with the original target fill rate. In some embodiments, a level of performance is computed from this comparison. For example, system 100 may determine that the liquidity provider is performing well, if the actual fill rate meets or exceeds the target fill rate. Conversely, if the actual fill rate fails to meet the target fill rate, system 100 may determine a poor level of performance.

In block 230, the processor may transmit a report about the level of performance to the liquidity provider. In some embodiments, the report may be sent on a regular basis over a determined frequency, such as daily, bi-weekly, weekly, month or any other increment of time.

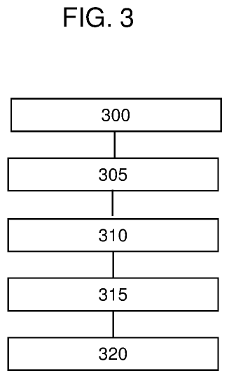

FIG. 3 depicts a flow diagram according to at least one embodiment of the methods disclosed herein.

In block 300, the processor may determine that the liquidity provider's actual fill rate fails to meet the target fill rate. As described above, system 100 may calculate the actual fill rate over a period of time spanning a day, a week, a month, or any increment of time. In some embodiments, system 100 is comparing the liquidity provider's actual fill rate to the target fill rate to determine the level of performance. in other embodiments, system 100 keeps track of the number of times the liquidity provider responses with a “no” denial over a period of time. The liquidity provider may trigger a threshold for the quantity of denials. For example, if a liquidity provider response with 3 “no” denials over the course of a day, system 100 may be triggered with an alert.

In block 305, the processor may send a warning indication to the liquidity provider. In some embodiments, the liquidity provider is given a grace period in order to improve the actual fill rate.

At the end of the grace period, system 100 may recalculate the actual fill rate, as shown in block 310. If the liquidity provider's actual fill rate still falls below the target fill rate, then system 100 may take the liquidity provider off the exchange, as shown in block 315. In one embodiment, the liquidity provider is prevented from trading until a criteria is met. In one embodiment, the criteria is the expiration of a penalty period of time. In another embodiment, system 100 will not route any orders to the liquidity provider during the penalty period of time. In other embodiments, the liquidity provider will be unable to log onto the system 100. In some embodiments, system 100 will send a notification to the liquidity provider indicating that trading privileges have been revoked due to the actual fill rate falling below the target fill rate. At the end of the penalty period, system 100 may send a notification to the liquidity provider, which indicates that trading privileges have been resorted.

In block 320, the processor may receive from the liquidity provider a request to change the original target fill rate. In some embodiments, the liquidity provider may wish to lower the target fill rate. Where a liquidity provider has been penalized multiple times, system 100 may wish to speak with a representative of the liquidity provider to perform further analysis.

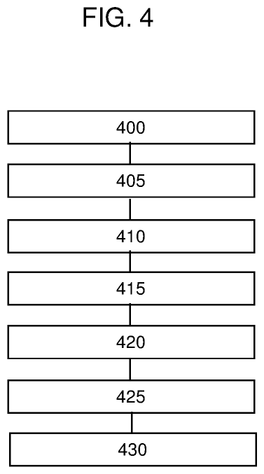

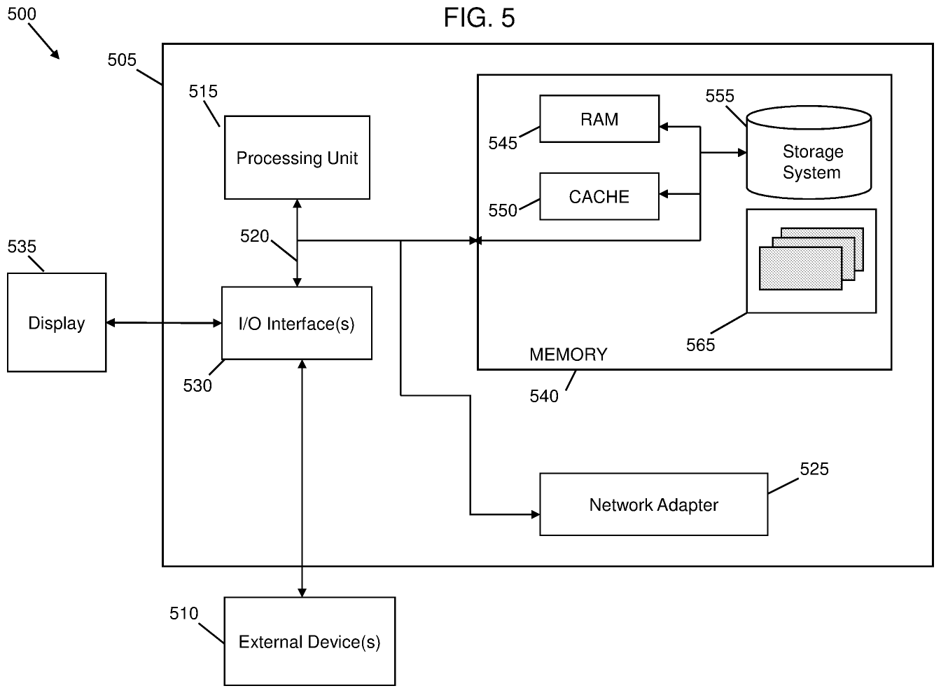

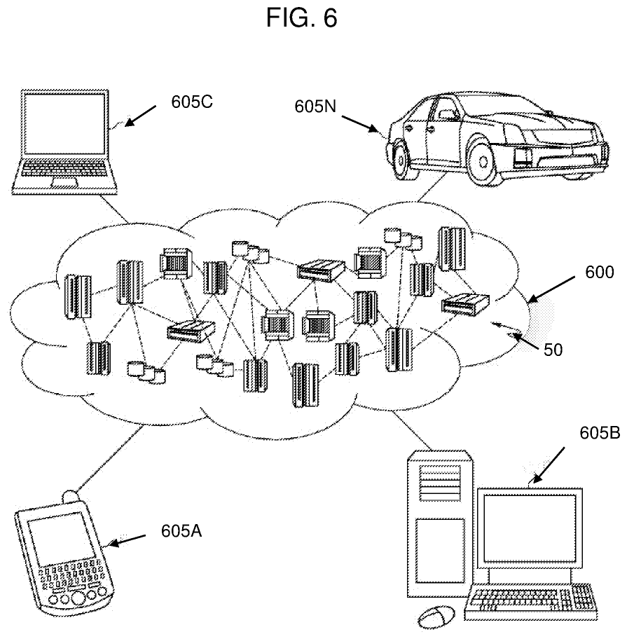

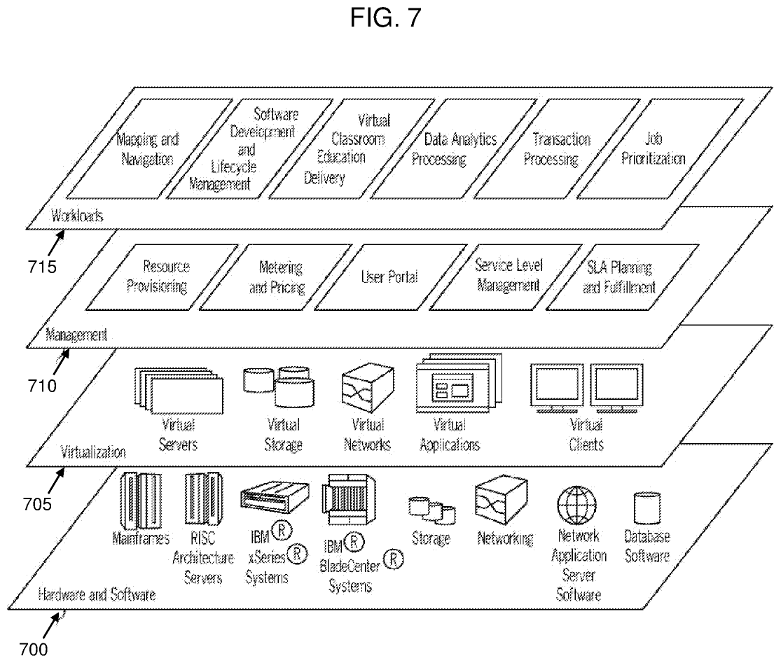

FIG. 4 depicts a flow diagram according to at least one embodiment of the methods disclosed herein.

In block 400, a liquidity provider on a remote device may receive an order from a liquidity taker on system 100. In some embodiments, the liquidity provider receives the order based on its indicated target fill rate. For example, the liquidity provider may have a target fill rate of 80% and the liquidity taker requested that system 100 only routes its orders with liquidity providers having fill rates above 70%.

In block 405, the liquidity provider may transmit a response indicating either an acceptance or a denial of the received order.

In block 410, the liquidity provider receives a report about its level of performance on the exchange. The level of performance is based on comparing the target fill rate with an actual fill rate. In some embodiments, the actual fill rate is update after each response. In some embodiments, the report is positive, indicating that the level of performance is consistent with the target fill rate. In other embodiments, the report indicates that there is room for improvement. The report may indicate that the level of performance is falling below the target fill rate.

In block 415, the liquidity provider may receive a warning that the level of performance has fallen below the target fill rate for a specified period of time. The liquidity provider may be given with an opportunity to improve the level of performance during a grace period of time.

In block 420, the liquidity provider may receive an indication that trading privileges will be suspended due to poor level of performance. The suspension period may last for a penalty period of time. At the end of the penalty period, the liquidity provider may receive a notice that trading privileges have been reinstated, as shown in block 425.

In block 430, the liquidity provider may submit a request to change the target fill rate to a different target fill rate.

### Cloud Computing

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### 1. Characteristics

Some characteristics of cloud computing are as follows:

a. On-demand self-service

A cloud consumer can unilaterally provision computing capabilities, such as server time and network storage, as needed, automatically without requiring human interaction with the service's provider.

Broad network access: capabilities are available over a network and accessed through standard mechanisms that promote use by heterogeneous thin or thick client platforms (e.g., mobile phones, laptops, and PDAs).

b. Resource pooling

The provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

c. Rapid elasticity

Capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

d. Measured service

Cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

### 2. Service Models

Various types of service models are as follows:

a. Software as a Service (SaaS)

The capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

b. Platform as a Service (PaaS)

The capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

c. Infrastructure as a Service (IaaS).

The capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### 3. Deployment Models

Various types of deployment models include:

a. Private cloud.

The cloud infrastructure is operated solely for an organization. It may be managed by the organization or a third party and may exist on-premises or off-premises.

b. Community cloud

The cloud infrastructure is shared by several organizations and supports a specific community that has shared concerns (e.g., mission, security requirements, policy, and compliance considerations). It may be managed by the organizations or a third party and may exist on-premises or off-premises.

c. Public cloud

The cloud infrastructure is made available to the general public or a large industry group and is owned by an organization selling cloud services.

d. Hybrid cloud.

The cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 5, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on, that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 505 in cloud computing node 500 is shown in the form of a general-purpose computing device. The components of computer system/server 505 may include, but are not limited to, one or more processors or processing units 515, a system memory 540, and a bus 520 that couples various system components including system memory 540 to processor 515.

Bus 520 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 505 typically includes a variety of computer system readable media. Such media may be any available media that is accessible by computer system/server 505, and it includes both volatile and non-volatile media, removable and non-removable media.

System memory 540 can include computer system readable media in the form of volatile memory, such as random access memory (RAM) 545 and/or cache memory 550. Computer system/server 505 may further include other removable/non-removable, volatile/non-volatile computer system storage media. By way of example only, storage system 555 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 520 by one or more data media interfaces. As will be further depicted and described below, memory 540 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Job priority program/utility 560, having a set (at least one) of program modules 565, may be stored in memory 540 by way of example, and not limitation, as well as an operating system, one or more application programs, other program modules, and program data. Each of the operating system, one or more application programs, other program modules, and program data or some combination thereof, may include an implementation of a networking environment. Program modules 565 generally carry out the functions and/or methodologies of embodiments of the invention as described herein.

Computer system/server 505 may also communicate with one or more external devices 14 such as a keyboard, a pointing device, a display 535, etc.; one or more devices that enable a user to interact with computer system/server 505; and/or any devices (e.g., network card, modem, etc.) that enable computer system/server 505 to communicate with one or more other computing devices. Such communication can occur via I/O interfaces 530. Still yet, computer system/server 505 can communicate with one or more networks such as a local area network (LAN), a general wide area network (WAN), and/or a public network (e.g., the Internet) via network adapter 525. As depicted, network adapter 525 communicates with the other components of computer system/server 505 via bus 520. It should be understood that although not shown, other hardware and/or software components could be used in conjunction with computer system/server 505. Examples include, but are not limited to: microcode, device drivers, redundant processing units, external disk drive arrays, RAID systems, tape drives, and data archival storage systems, etc.

Referring now to FIG. 6, illustrative cloud computing environment 600 is depicted. As shown, cloud computing environment 600 comprises one or more cloud computing nodes 500 with which local computing devices used by cloud consumers, such as, for example, personal digital assistant (PDA) or cellular telephone 605A, desktop computer 605B, laptop computer 605C, and/or automobile computer system 605N may communicate. Nodes 500 may communicate with one another. They may be grouped (not shown) physically or virtually, in one or more networks, such as private, community, public, or hybrid clouds as described hereinabove, or a combination thereof. This allows cloud computing environment 600 to offer infrastructure, platforms, and/or software as services for which a cloud consumer does not need to maintain resources on a local computing device. It is understood that the types of computing devices 605A-N shown in FIG. 6 are intended to be illustrative only and that computing nodes 500 and cloud computing environment 600 can communicate with any type of computerized device over any type of network and/or network addressable connection (e.g., using a web browser).

Referring now to FIG. 7, a set of functional abstraction layers provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 700 includes hardware and software components. Examples of hardware components include mainframes. In one example, IBM® zSeries® systems and RISC (Reduced Instruction Set Computer) architecture based servers. In one example, IBM pSeries® systems, IBM xSeries® systems, IBM BladeCenter® systems, storage devices, networks, and networking components. Examples of software components include network application server software. In one example, IBM WebSphere® application server software and database software. In one example, IBM DB2® database software. (IBM, zSeries, pSeries, xSeries, BladeCenter, WebSphere, and DB2 are trademarks of International Business Machines Corporation registered in many jurisdictions worldwide.)

Virtualization layer 705 provides an abstraction layer from which the following examples of virtual entities may be provided: virtual servers; virtual storage; virtual networks, including virtual private networks; virtual applications and operating systems; and virtual clients.

In one example, management layer 710 may provide the functions described below. Resource provisioning provides dynamic procurement of computing resources and other resources that are utilized to perform tasks within the cloud computing environment. Metering and pricing provide income tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 715 provides examples of functionality for which the cloud computing environment may be utilized. Examples of workloads and functions which may be provided from this layer include: determining the target fill rate for liquidity providers based on their response to routed orders; updating actual fill rates with received responses; and determining levels of performance. As mentioned above, all of the foregoing examples described with respect to FIG. 7 are illustrative only, and the invention is not limited to these examples.

It is understood all functions of the present invention as described herein are typically performed by the job prioritization, which can be tangibly embodied as modules of program code 565 of job priority program/utility 560 (FIG. 5). However, this need not be the case. Rather, the functionality recited herein could be carried out/implemented and/or enabled by any of the layers 700-715 shown in FIG. 7.

It is reiterated that although this disclosure includes a detailed description on cloud computing, implementation of the teachings recited herein are not limited to a cloud computing environment. Rather, the embodiments of the present invention are intended to be implemented with any type of clustered computing environment now known or later developed.

1. (canceled)

2. A method carried out through given electronic communication with a plurality of nodes in an electronic communications network communicatively coupled to one another and at least one computer as a first node of the plurality of nodes in the electronic communications network, the method comprising:
determining, by at least one processor of the at least one computer, a target fill rate designated by at least one liquidity provider as a second node of the plurality of nodes;
receiving, over the electronic communications network, by the at least one processor, from a liquidity taker as a third node of the plurality of nodes, based on the target fill rate being above a given percentage, an order to trade on an exchange;
after determining the target fill rate designated by the at least one liquidity provider, and in response to receiving the order, automatically routing, over the electronic communications network, by the at least one processor, the order to a graphical user interface of a display device of the at least one liquidity provider based at least in part on determining that the target fill rate designated by the at least one liquidity provider is above the given percentage;
receiving, over the electronic communications network, by the at least one processor, a response from the at least one liquidity provider, in which the response indicates either an acceptance or a denial of the order;
responsive to receiving the response, in real time dynamically updating, by the at least one processor, based on the response and whether the response is received from the at least one liquidity provider within a predetermined time that is less than one second from a time when the order is routed to the at least one liquidity provider, at least one actual fill rate of the at least one liquidity provider;
determining by the at least one processor, based on comparing the at least one actual fill rate of the at least one liquidity provider with the target fill rate, a level of performance for the at least one liquidity provider;
transmitting, over the electronic communications network, by the at least one processor, to the graphical user interface of the display device of the at least one liquidity provider, an electronic communication comprising a report about the at least one liquidity provider's level of performance;
automatically filtering, by the at least one processor, the at least one liquidity provider when the at least one actual fill rate of the at least one liquidity provider is determined to be below the given percentage;
determining, by the at least one processor that the at least one actual fill rate fails to meet the target fill rate; and
responsive to a determination that the at least one actual fill rate fails to meet the target fill rate,
transmitting, over the electronic communications network by the at least one processor, an electronic notification via email to the at least one liquidity provider indicating that trading privileges have been revoked; and
disabling, by the at least one processor, any future trading by the at least one liquidity provider on an electronic exchange system associated with the at least one computer, by preventing routing of any future orders from the electronic exchange system to the at least one liquidity provider during a penalty period of time determined responsive to a determination that the at least one actual fill rate is below the given percentage.

3. The method of claim 2, in which the at least one liquidity provider agrees to the target fill rate prior to trading on the exchange.

4. The method of claim 2, in which the response indicates a denial, and in which the denial comprises: receiving no response from the at least one liquidity provider within a period of time for responding.

5. The method of claim 2, in which determining the level of performance for the at least one liquidity provider further comprises: comparing the at least one actual fill rate with the target fill rate to determine a level of performance.

6. The method of claim 2 , in which the any future orders are received over the electronic communications network from a given liquidity taker as a given node of the plurality of nodes during the penalty period of time.

7. The method of claim 2 further comprising: determining that the at least one actual fill rate fails to meet the target fill rate for a period of time.

8. The method of claim 2 further comprising: transmitting an indication that the at least one actual fill rate failed to meet the target fill rate.

9. The method of claim 2 further comprising: providing the at least one liquidity provider with an opportunity to improve the at least one actual fill rate.

10. The method of claim 2 further comprising: determining that the at least one liquidity provider triggers a threshold quantity of denials.

11. The method of claim 10 further comprising: in response to a determination that the at least one liquidity provider triggers the threshold quantity of denials, preventing, by the at least one processor, routing of any future orders from the electronic exchange system to the at least one liquidity provider during the penalty period of time.

12. The method of claim 2, in which the exchange is operable on a cloud computing system.

13. An apparatus comprising:
at least one processor of at least one computer in electronic communication with a plurality of other computers via an electronic communications network; and
at least one memory, in which the at least one memory stores instructions which, when executed by the at least one processor, direct the at least one processor to:
determine a target fill rate designated by at least one liquidity provider as a first computer of the plurality of other computers;
receive, over the electronic communications network, from a liquidity taker as a second computer of the plurality of other computers, based on a target fill rate being above a given percentage, an order to trade on an exchange;
after determining the target fill rate designated by the at least one liquidity provider, and in response to receiving the order, automatically route, over the electronic communications network, the order to at least one liquidity provider based at least in part on determining that the target fill rate designated by the at least one liquidity provider is above the given percentage;
receive, over the electronic communications network, a response from the at least one liquidity provider, in which the response indicates either an acceptance or a denial of the order;
responsive to receiving the response, in real time dynamically update at least one actual fill rate of the at least one liquidity provider based on whether the response is received from the at least one liquidity provider within a predetermined time that is less than one second from a time when the order is routed to the at least one liquidity provider;
compare the at least one actual fill rate of the at least one liquidity provider with the target fill rate to determine a level of performance;
transmit, over the electronic communications network, a report about the at least one liquidity provider's level of performance;
automatically filter the at least one liquidity provider when the at least one actual fill rate of the at least one liquidity provider is determined to be below the given percentage;
determining that the at least one actual fill rate fails to meet the target fill rate; and
responsive to a determination that the at least one actual fill rate fails to meet the target fill rate,
transmitting, over the electronic communications network, an electronic notification via email to the at least one liquidity provider indicating that trading privileges have been revoked; and
disabling any future trading by the at least one liquidity provider on an electronic exchange system associated with the at least one computer, by preventing routing of any future orders from the electronic exchange system to the at least one liquidity provider during a penalty period of time determined responsive to a determination that the at least one actual fill rate is below the given percentage.

14. The apparatus of claim 13, in which the at least one liquidity provider agrees to the target fill rate prior to trading on the exchange.

15. The apparatus of claim 13, in which determining the level of performance for the at least one liquidity provider further comprises: comparing the at least one actual fill rate with the target fill rate to determine a level of performance.
